(19) United States
(12) Patent Application Publication
(10) Pub. No.: US 2009/0315428 A1
(43) Pub. Date: Dec. 24, 2009

(54) LAMINATION OF STATOR OF THREE-PHASE MOTOR FOR INCREASING WINDING SPACE

(76) Inventors: Cheng-Chun Chou, Ping Tung (TW); Tsung-Ming Liu, Ping Tung (TW); Chien-Jung Lin, Ping Tung (TW); Yen-Min Su, Ping Tung (TW); Yung-Sheng Tang, Ping Tung (TW)

Correspondence Address: Hershkovitz & Associates, LLC, 2845 Duke Street, Alexandria, VA, 22314, US

(21) Appl. No.: 12/143,913

(22) Filed: Jun. 23, 2008

(51) Int. Cl. H02K 3/46

(52) U.S. Cl. 310/216.053; 310/216.069

(57) ABSTRACT

A lamination of a stator of a three-phase motor has a core ring and multiple winding frames. Each winding frame has a body and two wings. The body is implemented for winding wires thereon, is elongated and defines two side edges and an outer end. The wings oppositely protrude transversely from the outer end of the body and each defines an inner edge adjacent to one corresponding side edge of the adjacent body to retain the wires wound on the body. The inner edges of the wings are formed perpendicular to, or slightly outward relative to the side edges of the body. Such that interference between the wings and wound wires near the outer ends of the bodies can be prevent, and a capacity of the winding space defined around the body is increased and an efficient of wire winding is ensured.

### BACKGROUND OF THE INVENTION

1. Field of the Invention

The present invention relates to a stator, and more particularly to a lamination of a stator of a three-phase motor to increase wire winding capacity and avoid damaging the wires.

2. Description of Related Art

With reference to FIGS. 6 to 8, a stator of a three-phase motor is composed of stacks of laminations. A conventional lamination of the stator has a core ring (90) and multiple winding frames (80). The core ring (90) is defined with a central hole (91) allowing an extension of an axle. The winding frames (80) separately protrude around the core ring (90) in intervals, and each winding frame (80) comprises a body (81) and two wings (82). The body (81) is implemented for winding wires thereon, is elongated and defines two side edges (84) and an outer end. The wings (82) oppositely protrude transversely from the outer end of the body (81) and each defines an inner edge (83) adjacent to one corresponding side edge (84) of the adjacent body (81) to retain the wires wound on the body (81).

With further reference to FIG. 5, the inner edges (83) of the wings (82) extend inwardly relative to the body (81), thus acute angles (87) are formed between the inner edges (83) of the wings (82) and the side edges (84) of the body (81). However, this may obstruct wire winding near the outer end of the body (81) and eventually lead to limit a winding spaces (86) defined around the body (81) and reduce of number of wire winding. Additionally, each wing (82) has a sharp tip (85) may damage the wire.

The present invention therefore provides a lamination of stator of three-phase motor to obviate or mitigate the aforementioned problems.

### SUMMARY OF THE INVENTION

The main objective of the present invention is to provide a lamination of a stator of a three-phase motor for increasing winding spaces.

To achieve the objective, the lamination has a core ring and multiple winding frames. Each winding frame comprises a body and two wings. The body is implemented for winding wires thereon, is elongated and defines two side edges and an outer end. The wings oppositely protrude transversely from the outer end of the body and each defines an inner edge adjacent to one corresponding side edge of the adjacent body to retain the wires wound on the body. The included angles defined between the inner edges of the wings and the side edges of the body are equal or larger than 90 degree. Preferably, the inner edges of the wings are formed perpendicular to, or slightly outward relative to the side edges of the body. Accordingly, interference between the wings and wound wires near the outer ends of the bodies can be prevent, and winding spaces defined around the body are increased and a large wire winding capacity is ensured. Furthermore, each wing has a round tip that avoids damaging of the wires.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lamination of a stator of a three-phase motor in accordance with the present invention;

FIG. 2 is a top view of the lamination of a stator of a three-phase motor in FIG. 1;

FIG. 3 is an operational top view of the lamination in FIG. 1 wound with wires;

FIG. 4 is a partially enlarged top view of the lamination in FIG. 1;

FIG. 5 is a partially enlarged top view of a lamination of a stator of a three-phase motor in accordance with prior art;

FIG. 6 is a perspective view of a lamination of a stator of a three-phase motor in FIG. 5;

FIG. 7 is a top view of the lamination in FIG. 6; and

FIG. 8 is an operational top view of the lamination in FIG. 7 wound with wires.

### DETAILED DESCRIPTION OF THE PREFERRED EMBODIMENT

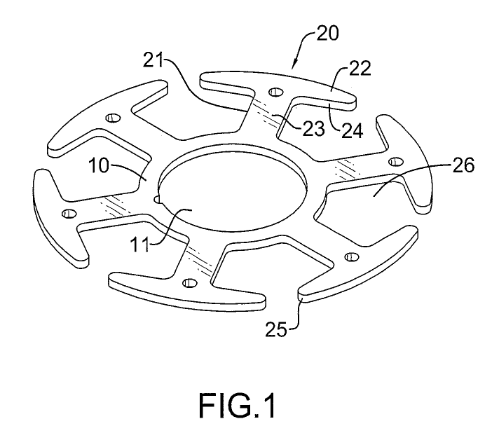

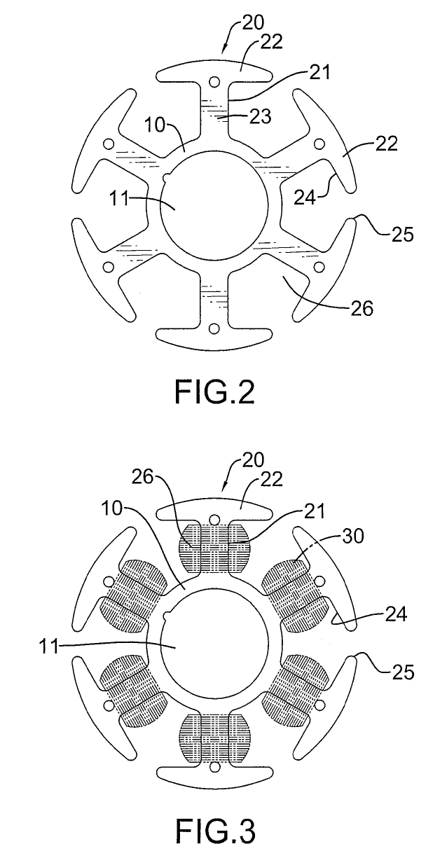

With reference to FIGS. 1, 2 and 3, a stator of a three-phase motor is composed of stacks of laminations. A lamination in accordance with the present invention has a core ring (10) and multiple winding frames (20).

The core ring (10) is circular and is defined with a central hole (11) allowing an extension of an axle.

The winding frames (20) separately protrude around the core ring (10) in intervals, and each winding frame (20) is T-shaped and comprises a body (23) and two wings (22). The body (23) is implemented for winding wires (30) thereon, is elongated and defines a winding space (26) around the body (23), two side edges (21) and an outer end. The wings (22) oppositely protrude transversely from the outer end of the body (23) and each defines an inner edge (24) adjacent to one corresponding side edge (21) of the adjacent body (23) to retain the wires (30) wound on the body (23).

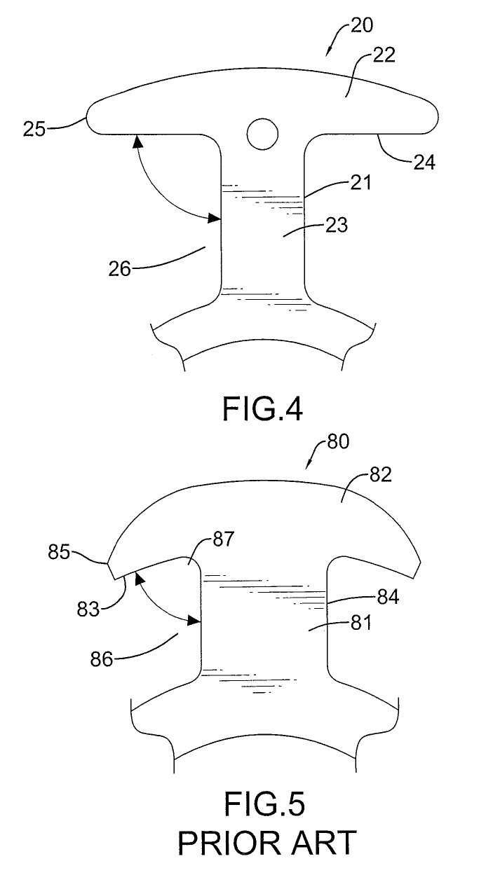

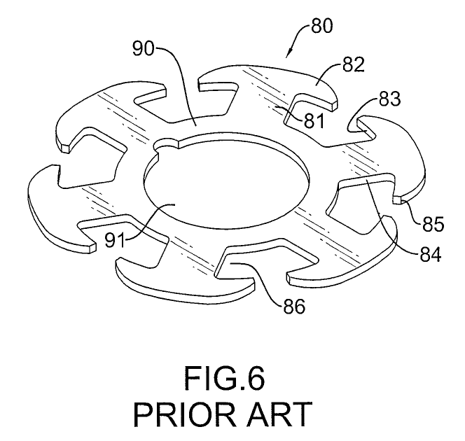

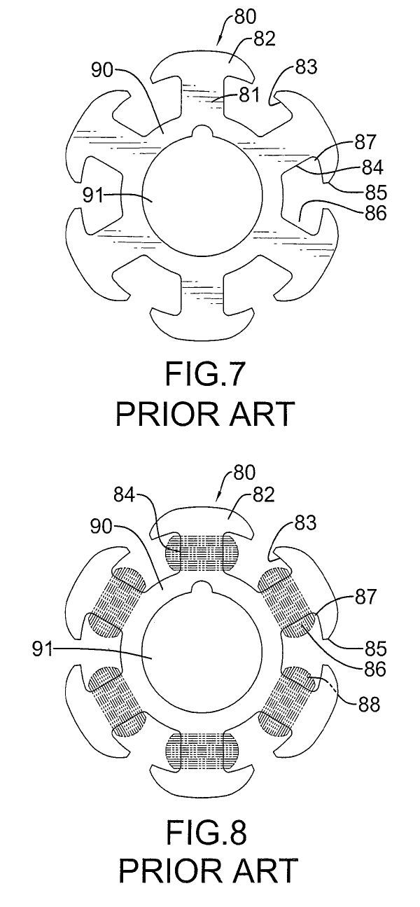

With further reference to FIG. 4, the inner edges (24) of the wings (22) are formed perpendicular to the side edges (21) of the body (23). Thus, multiple included angles defined between the inner edges (24) of the wings (22) and the side edges (21) of the body (23) are at least 90 degree. Such that interference between the wings (22) and wound wires (30) near the outer ends of the bodies (23) can be prevent, and a capacity of the winding spaces (26) defined around the body (23) is increased and an efficient of wire winding is ensured.

Additionally, each wing (22) has a round tip (25) that avoids damaging of the wires (30).

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A lamination of a stator of a three-phase motor comprising
a core ring; and
multiple winding frames separately protruding around the core ring in intervals, and each winding frame comprising
a body implemented for winding wires thereon, being elongated and defining a winding space around the body, two side edges and an outer end; and
two wings oppositely protruding transversely from the outer end of the body and each defining an inner edge adjacent to one corresponding side edge of an adjacent body to retain the wires wound on the body,
wherein the inner edges of the wings of each winding frame are formed perpendicular to the side edges of the body of the winding frame.

2. The lamination of stator of three-phase motor as claimed in claim 1, wherein each wing further has a round tip.

3. The lamination of stator of three-phase motor as claimed in claim 2, wherein the core ring is circular and is defined with a central hole.
